(19) United States
(12) Patent Application Publication
(10) Pub. No.: US 2026/0348491 A1
(43) Pub. Date: Nov. 5, 2026

(54) PIPE STAND

(71) Applicant: MILWAUKEE ELECTRIC TOOL CORPORATION, Brookfield, WI (US)

(72) Inventors: Ryan J. Denissen, Sussex, WI (US); Austin D. Clarke, Park Ridge, IL (US); Isabel D. Haut, Kankakee, IL (US); Stacia L. Brooks, San Jose, CA (US); Jacob A. Gray, West Lafayette, IN (US); Reuben C. Jevremovic, South Bend, IN (US)

(21) Appl. No.: 19/664,404

(22) Filed: Apr. 30, 2026

Related U.S. Application Data
(60) Provisional application No. 63/797,256, filed on Apr. 30, 2025.

(51) Int. Cl. F16L 3/02

(52) U.S. Cl. CPC F16L 3/02

(57) ABSTRACT

A pipe stand includes a base, a support tube coupled to the base, a support rod slidably received within the support tube, and a height adjustment mechanism. The support rod has a support head with a plurality of arms. The height adjustment mechanism includes a guide channel formed on the support tube. The guide channel has a plurality of notches. The height adjustment mechanism further includes a knob coupled to the support rod and movable within the guide channel. The knob is configured to be positioned within one of the notches to adjust a height of the support head relative to the base.

### CROSS-REFERENCE TO RELATED APPLICATIONS

The present application claims priority to U.S. Provisional Patent Application No. 63/797,256, filed April 30, 2026, the entire content of which is incorporated herein by reference.

### FIELD OF THE DISCLOSURE

The present disclosure relates to pipe supports, and more particularly to adjustable pipe stands for holding a pipe during threading, welding, cutting, or other operations.

### BACKGROUND OF THE DISCLOSURE

Pipe stands are commonly used in construction, plumbing, and industrial settings to support pipes during threading, welding, cutting, and other operations. These stands typically include a base for stability and a pipe holder or support head on a rod that can be adjusted to various heights to accommodate different working conditions and pipe sizes. To adjust the height of the pipe stand, some conventional pipe stands include a lock ring surrounding the rod and a hand screw for tightening a screw against the outside of the rod. The lock ring is lifted by the user to extend the rod and then lowered again to engage the outside of the rod. The hand screw is then used to tighten the screw against the outside of the rod to anchor the rod in the selected position. Other conventional pipe stands utilize washer locking mechanisms that wedge into a center column of the pipe stand when force is applied (e.g., from the weight of the pipe).

### SUMMARY OF THE DISCLOSURE

Locking mechanisms on conventional pipe stands are often difficult to adjust due to the weight of the pipe. For example, a lock ring can be difficult to dislodge from the outer circumference of the rod to allow for height adjustment, which may lead to the user needing to use tools to apply enough force to dislodge the lock ring. Friction-based designs can be effective for stability during use, but they may present challenges when the height of the pipe stand is to be changed. The loads resting on the washer mechanism can make it difficult to release the locking mechanism without applying substantial force. Finally, carrying mechanisms on conventional pipe stands may not provide comfortable gripping positions or may cause the stand to rest at an awkward angle during transport.

Accordingly, a need exists for improved pipe stands that address one or more of these considerations.

In some aspects, the techniques described herein relate to a pipe stand that includes a base, a support tube coupled to the base, a support rod slidably received within the base that has a support head with a plurality of arms, and a height adjustment mechanism. The height adjustment mechanism includes a guide channel formed on the support tube and has a plurality of notches, and a knob coupled to the support rod and movable within the guide channel. The knob is configured to be positioned within one of the notches to adjust a height of the support head relative to the base.

Other aspects of the disclosure will become apparent by consideration of the detailed description and accompanying drawings.

### BRIEF DESCRIPTION OF THE DRAWINGS

FIG. 1 is a perspective view of a pipe stand according to an embodiment of the present disclosure and illustrated in an extended position.

FIG. 2 is a perspective view of the pipe stand of FIG. 1 in a stowed position.

FIG. 3 is an enlarged, side view of a height adjustment mechanism of the pipe stand of FIG. 1.

FIG. 4 is a perspective view of another embodiment of a support head for use with the pipe stand of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein and in the appended claims, the terms “upper”, “lower”, “top”, “bottom”, “front”, “back”, and other directional terms are not intended to require any particular orientation but are instead used for purposes of description only.

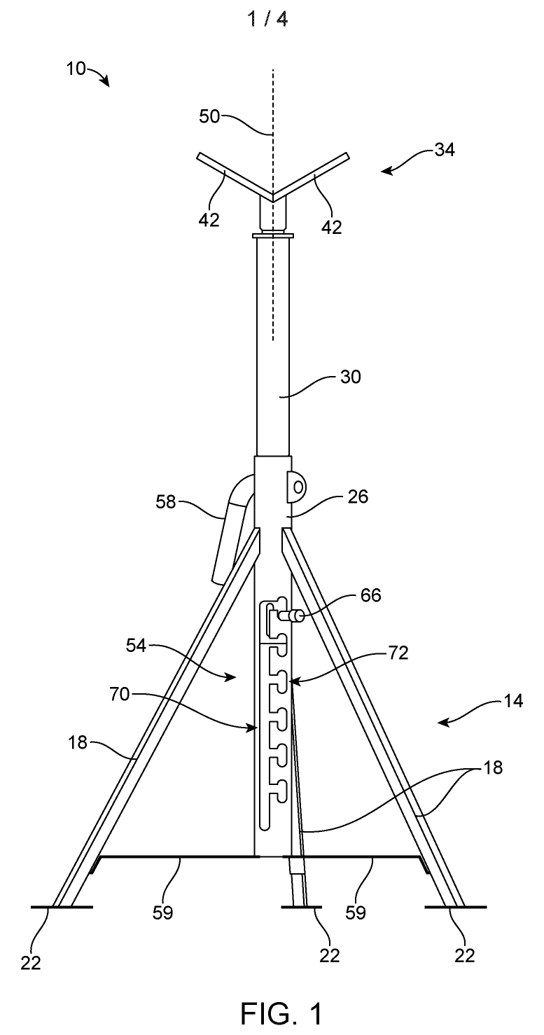

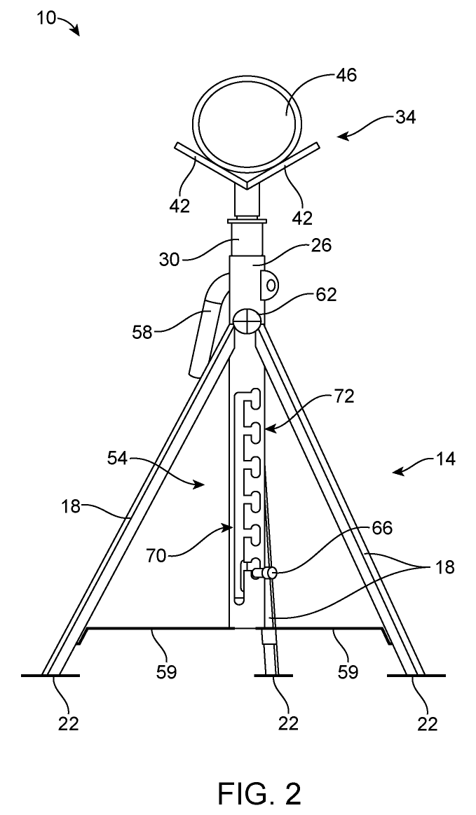

FIGS. 1-2 illustrate a pipe stand 10 in accordance with an embodiment of the present disclosure. The pipe stand 10 includes a base 14 having a plurality of support legs 18 extending from a support tube 26. Each of the illustrated support legs 18 includes a support foot 22 configured to support the pipe stand 10 on the ground, a floor, or other suitable surface. The support feet 22 may be formed from a durable material such as rubber, plastic, or metal to provide traction and stability on various surfaces. The illustrated base 14 includes three support legs 18 generally equally spaced to form a tripod support; however, a greater number or different arrangement of support legs 18 may be used in other embodiments. For example, in some embodiments, four or more support legs 18 may be utilized to provide additional stability for heavier workpieces. In some embodiments, the support legs 18 may be pivotally coupled to the support tube 26 so as to be pivoted between a retracted position (not shown), in which the support legs 18 extend generally adjacent the support tube 26 to facilitate storage and transport, and an expanded position, (e.g., FIG. 1), in which the feet 22 of the support legs 18 are spread apart for greater stability. In other embodiments, the support legs 18 may be fixed in position (and, in some such embodiments, welded to the support tube 26). For example, in the illustrated embodiment the support legs 18 are non-foldable legs that are each supported by a support brace 59. A bottom portion of the support tube 26 is both coupled to and supported by the support braces 59. The support braces 59 provide additional structural rigidity to the base 14 and help distribute loads applied to the pipe stand 10 during use.

With continued reference to FIGS. 1 and 2, the illustrated pipe stand 10 includes a support rod 30 slidably received within the support tube 26, and a support head 34 mounted on the support rod 30. The support rod 30 may be formed from a high-strength material such as steel or aluminum to withstand the weight of heavy pipes and other workpieces. The support head 34 includes a plurality of arms 42 for receiving a pipe 46 (FIG. 2) or other workpieces. The illustrated arms 42 are generally arranged in a V-shape in the illustrated embodiment, which facilitates support of a variety of differently sized tubular pipes 46. The V-shaped configuration of the arms 42 allows pipes 46 of varying diameters to be securely cradled within the support head 34 without requiring additional adjustment or accessories. In some embodiments, the arms 42 may include rollers or low-friction surfaces to facilitate rotation of the pipe 46 during threading, welding, cutting, or other operations.

The support rod 30 extends along a longitudinal axis 50 that is coaxial with the support tube 26. The height of the support head 34 is adjustable with respect to the base 14 between a stowed position (FIG. 2) and an extended position (FIG. 1). The stowed position provides a compact configuration for storage and transport, while the extended position allows the support head 34 to be raised to a working height suitable for various pipe operations. The stand 10 further includes a height adjustment mechanism 54 for adjusting the height of the support head 34 relative to the base 14 along the longitudinal axis 50, as described in greater detail below.

With continued reference to FIGS. 1-2, the pipe stand 10 further includes a handle 58 extending from the support tube 26. The illustrated handle 58 is located above the height adjustment mechanism 54, such that a center of gravity 62 of the stand 10 is positioned below the handle 58 when the stand 10 is positioned in the stowed position (FIG. 2). With the center of gravity 62 positioned below the handle 58 in the stowed position, the stand 10 is more easily maneuverable during transport by a user between jobsites. This configuration reduces user fatigue and allows for single-handed carrying of the stand 10. In some embodiments, the handle 58 is manufactured from 4130 steel, which provides an high strength-to-weight ratio and durability. In other embodiments, the support rod 30 and support tube 26 are also manufactured from 4130 steel. The handle 58 may be welded to the support tube 26 and is cantilevered from the support tube 26 in the illustrated embodiment. In other embodiments, the handle 58 may be fastened to the support tube 26 using bolts, screws, or other mechanical fasteners. The handle 58 may also include an ergonomic grip or cushioned surface to enhance user comfort during transport.

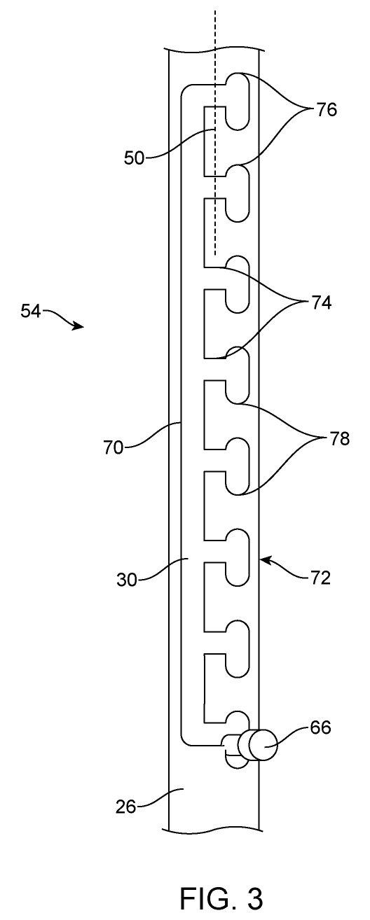

With reference to FIGS. 1-3, the height adjustment mechanism 54 includes an adjustment knob 66 fixed to and extending outwardly from the support rod 30, and a guide channel 70 formed in the support tube 26. In some embodiments, the adjustment knob 66 is threaded to the support rod 30, allowing for secure attachment while also permitting removal or replacement if necessary. In other embodiments, the adjustment knob 66 may be welded, pinned, or otherwise permanently affixed to the support rod 30. The adjustment knob 66 is received within the guide channel 70 for movement along the guide channel 70. Movement of the adjustment knob 66 moves the support rod 30 and thus, the support head 34, relative to the base 14. The illustrated guide channel 70 includes a plurality of adjustment notches 72, each defining cross channels 74 and lock slots 78 for selectively receiving the adjustment knob 66. The adjustment knob 66 is configured to slide along a selected cross channel 74 and into the associated lock slot 78 so the adjustment knob 66 is seated in the slot 78. This configuration provides positive locking engagement that securely retains the support rod 30 at the selected height position. In some embodiments, the adjustment notches 72 extend generally transverse to the longitudinal axis 50, while the lock slots 78 are oriented parallel to the longitudinal axis 50. The perpendicular relationship between the cross channels 74 and the lock slots 78 creates a bayonet-style locking mechanism that resists inadvertent disengagement during use.

To adjust the height of the support head 34 relative to the base 14 between the stowed position and the extended position, the adjustment knob 66 is maneuvered along the guide channel 70 to an entrance of one of the adjustment notches 72 corresponding with a desired height. When one of the adjustment notches 72 is chosen, the adjustment knob 66 is moved into and along the cross channel 74 of the chosen adjustment notch 72, which rotates the support rod 30 about the longitudinal axis 50, to be seated within the respective lock slot 78. This rotational movement provides tactile feedback to the user, confirming that the adjustment knob 66 is properly engaged within the lock slot 78. To move the adjustment knob 66 to one of the different adjustment notches 72, the adjustment knob 66 is lifted and aligned with the cross channel 74 and moved back out into the guide channel 70. Since the user is required to align the adjustment knob 66 with the cross channel 74 for moving the adjustment knob 66 to a different adjustment notch 72, the adjustment knob 66 is inhibited from shifting into the guide channel 70 on its own during transport of the stand 10, avoiding unintentional extending of the support rod 30. Additionally, to aid in the retention of the adjustment knob 66 in the selected notch 72 during transport, each of the adjustment notches 72 includes a retention slot 76 opposite the lock slot 78. The retention slot 76 is configured to receive the adjustment knob 66 when the stand 10 is transported or shaken to prevent the adjustment knob 66 from shifting into the guide channel 70. The dual-slot configuration of each adjustment notch 72, including both the lock slot 78 and the retention slot 76, provides redundant retention that enhances the security and reliability of the height adjustment mechanism 54.

In some embodiments, the stand 10 is in the stowed position when the adjustment knob 66 is seated within the lowermost adjustment notch 72, and the stand 10 is in the extended position when the adjustment knob 66 is seated within the uppermost adjustment notch 72. In addition to the stowed and extended positions, the support head 34 can also be adjusted to one or more intermediate positions between the extended position and the stowed position corresponding to one of the adjustment notches 72 between the uppermost notch and the lowermost notch. The plurality of intermediate positions allows the user to select a height that is optimal for the specific pipe operation being performed, the height of the user, or the height of adjacent equipment such as a pipe threading machine or welding table. In some embodiments, the adjustment notches 72 are spaced at regular intervals along the guide channel 70 to provide consistent height increments. In other embodiments, the spacing between adjacent adjustment notches 72 may vary to provide finer adjustment at commonly used heights.

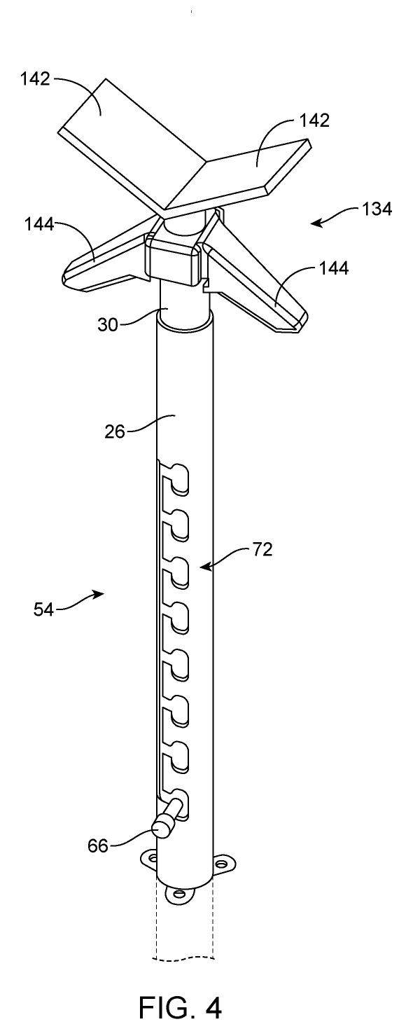

FIG. 4 illustrates another embodiment of a support head 134 for use with the stand 10. The support head 134 includes a plurality of arms 142 for receiving a workpiece (e.g., a pipe), and a plurality of hand supports 144 located on the support rod 30. The arms 142 of the support head 134 may be arranged in a cross configuration or other arrangement suitable for supporting various workpiece shapes and sizes. Each of the hand supports 144 functions as a handle for aiding the user in transporting the stand 10 between jobsites. The hand supports 144 may be positioned at multiple locations along the support rod 30 to accommodate users of different heights or to provide alternative gripping positions. In some embodiments, the hand supports 144 may include textured or cushioned surfaces to enhance grip and user comfort.

By utilizing the height adjustment mechanism 54, a user is more easily able to adjust the height of the support head 34 relative to the base 14 without the need for outside tools (e.g., a hammer) or user force as compared to other conventional height adjustment methods for pipe supports. The tool-free operation of the height adjustment mechanism 54 reduces setup time and allows for rapid height changes during pipe operations. Additionally, the positive locking engagement provided by the adjustment notches 72 ensures that the support head 34 remains securely positioned at the selected height, even when supporting heavy pipes or when subjected to forces during threading, welding, cutting, or other operations. The height adjustment mechanism 54 also reduces the risk of user injury that may occur when using excessive force or tools to adjust conventional pipe supports.

Although the disclosure has been described in detail with reference to certain preferred embodiments, variations and modifications exist within the scope and spirit of one or more independent aspects of the disclosure as described.

Various features and advantages of the disclosure are set forth in the following claims.

What is claimed is:

1. A pipe stand comprising:
a base;
a support tube coupled to the base;
a support rod slidably received within the support tube, the support rod having a support head with a plurality of arms; and
a height adjustment mechanism including
a guide channel formed on the support tube, the guide channel having a plurality of notches, and
a knob coupled to the support rod and movable within the guide channel, the knob being configured to be positioned within one of the notches to adjust a height of the support head relative to the base.

2. The pipe stand of claim 1, further comprising a handle coupled to one of the support rod or the support tube.

3. The pipe stand of claim 1, wherein the base includes a plurality of support legs that are non-foldable and are each supported by a support brace.

4. The pipe stand of claim 1, wherein each of the notches includes a cross channel and a lock slot configured to selectively retain the knob.

5. The pipe stand of claim 1, wherein the support head is adjustable between a first position where the knob is positioned within a lowermost notch, a second position where the knob is positioned within an uppermost notch, and an intermediate position located between the first and second position.

6. The pipe stand of claim 1, wherein each of the notches includes a retention slot opposite a lock slot, the retention slot being configured to receive the knob to prevent the knob from shifting into the guide channel during transport.

7. The pipe stand of claim 1, wherein the plurality of arms are arranged in a V-shape configuration.

8. The pipe stand of claim 1, wherein the support rod extends along a longitudinal axis that is coaxial with the support tube.

9. The pipe stand of claim 1, wherein the base includes three support legs generally equally spaced to form a tri-pod support.

10. The pipe stand of claim 1, further comprising a plurality of hand supports located on the support rod.

11. A pipe stand comprising:
a base including a plurality of support legs extending from a support tube;
a support rod slidably received within the support tube;
a support head mounted on the support rod, the support head including a plurality of arms for receiving a pipe; and
a height adjustment mechanism including a guide channel formed in the support tube and an adjustment knob fixed to the support rod, the guide channel including a plurality of adjustment notches each having a cross channel and a lock slot, the adjustment knob being configured to slide along a selected cross channel and into the associated lock slot to secure the support rod at a desired height position.

12. The pipe stand of claim 11, wherein each of the adjustment notches includes a retention slot opposite the lock slot, the retention slot being configured to receive the adjustment knob when the pipe stand is transported.

13. The pipe stand of claim 11, wherein the cross channels extend generally transverse to a longitudinal axis of the support rod, and the lock slots are oriented parallel to the longitudinal axis.

14. The pipe stand of claim 11, further comprising a handle extending from the support tube, wherein a center of gravity of the pipe stand is positioned below the handle when the support head is in a stowed position.

15. The pipe stand of claim 11, wherein the plurality of support legs are non-foldable and are each supported by a support brace coupled to the support tube.

16. The pipe stand of claim 11, wherein movement of the adjustment knob along the cross channel rotates the support rod about a longitudinal axis of the support rod.

17. A pipe stand comprising:
a base;
a support tube extending from the base;
a support rod slidably received within the support tube and extending along a longitudinal axis coaxial with the support tube;
a support head mounted on the support rod; and
a height adjustment mechanism including a guide channel formed in the support tube and an adjustment knob extending outwardly from the support rod, the guide channel including a plurality of adjustment notches, each adjustment notch including a cross channel extending transverse to the longitudinal axis, a lock slot oriented parallel to the longitudinal axis, and a retention slot opposite the lock slot.

18. The pipe stand of claim 17, wherein the support head includes a plurality of arms arranged in a V-shape configuration for receiving pipes of varying diameters.

19. The pipe stand of claim 17, further comprising a handle extending from the support tube and positioned above the height adjustment mechanism.

20. The pipe stand of claim 17, wherein the adjustment knob is configured to be aligned with the cross channel and moved into the guide channel to move the adjustment knob to a different adjustment notch.
